(19) United States
(12) Patent Application Publication
(10) Pub. No.: US 2011/0111641 A1
(43) Pub. Date: May 12, 2011

(54) CONNECTOR

(75) Inventors: Katsuhiko Nakazawa, Tokyo (JP); Yasukazu Itou, Tokyo (JP)

(73) Assignee: JAPAN AVIATION ELECTRONICS INDUSTRY, LIMITED, Tokyo (JP)

(21) Appl. No.: 12/938,471

(22) Filed: Nov. 3, 2010

(30) Foreign Application Priority Data
Nov. 6, 2009 (JP) 2009-255141

(51) Int. Cl. H01R 24/00

(52) U.S. Cl. 439/660

(57) ABSTRACT

A connector whose terminal portions of contacts can be reliably inserted into through holes of a circuit board. The connector comprises a housing, contacts, and an alignment member. Each contact includes a holding portion held by the housing, a terminal portion inserted into a circuit board, and a linking portion connecting the holding and terminal portions. The alignment member is mounted on the contacts and positions the terminal portions. The contacts are arranged in a longitudinal direction of the connector, and in two rows in a vertical direction thereof. Each pair of adjacent contacts in the longitudinal direction are connected by a connecting portion, to form first and second combination contacts. The alignment member has receiving portions receiving the linking portions, open portions from which the connecting portions are exposed, and grooves preventing a relative movement of the connecting portions in the vertical direction.

### BACKGROUND OF THE INVENTION

1. Field of the Invention

This invention relates to a connector.

2. Description of Related Art

Conventionally, there has been proposed a connector comprised of a plurality of contacts, a housing, and a locator (alignment member) (see Japanese Laid-Open Patent Publication (Kokai) No. 2001-006771, Paragraph Nos. 0007 to 0012 and FIGS. 9 and 10).

Each of the contacts is formed into a substantially L shape and includes a connection portion, a press-fit portion (terminal portion), and a lead terminal portion (linking portion). The connection portion is formed into a fork shape. A longitudinal direction of the press-fit portion is substantially perpendicular to a longitudinal direction of the connection portion. The press-fit portion is press-fitted into an associated one of through holes of a printed circuit board. The lead terminal portion connects between the connection portion and the press-fit portion. A wide portion is formed in the connecting region of the press-fit portion and the lead terminal portion.

The housing has contact receiving holes formed therein at predetermined space intervals along a longitudinal direction thereof. The plurality of contact receiving holes are vertically disposed in three rows (three rows comprised of a row of a contact receiving hole group located in an upper level, a row of a contact receiving hole group located in a middle level, and a row of a contact receiving hole group located in a lower level). The connection portions of the contacts are held by the housing in a state where the connection portions are received in the contact receiving holes.

The locator includes a plurality of slits and a plurality of pairs of protrusions. The lead terminal portions of the plurality of contacts held by the housing are inserted into the plurality of slits, respectively. The pairs of protrusions are each formed on an inner wall surface of each slit of the locator. The wide portion of the contact is engaged with a recesses formed in the lower surface of each protrusion. Also, the protrusion has a tapered face. The tapered face prevents the protrusion from blocking the insertion of the lead terminal portion when the lead terminal portion is inserted into the slit.

To assemble the connector, first, the connection portions of the contacts are received in the contact receiving holes of the housing, respectively, and the housing is caused to hold the contacts.

Next, the press-fit portions, the wide portions, and the lead terminal portions of the contacts are inserted into the slits of the locator, respectively. In doing so, each wide portion climbs onto the tapered face of the protrusion, and move in an array direction of the contacts against the spring force of the lead terminal portion. When the wide portion of the contact passes the protrusion, the wide portion moves downward of the protrusion by the spring force of the lead terminal portion, and engages with the recess of the lower surface of the protrusion.

By the above-described operation, the assembly of the connector is completed.

To mount the connector on the printed circuit board, leading end portions of the press-fit portions of the contacts are inserted into the through holes of the printed circuit board, respectively, and then an upper surface of the locator is pressed by using e.g. a press.

The pressing force applied to the locator by the press and the like is passed to the wide portions of the contacts via the protrusions of the locator, whereby the entire press-fit portions are press-fitted into the through holes.

In the above-described connector, when each contact is inserted into the locator, there is a fear that the protrusion is cut or shaved by the wide portion of the contact.

When the protrusion is cut, the engagement between the protrusion and the wide portion cannot be maintained, and there is a fear that it is impossible to reliably insert the press-fit portion of the contact into the associated through hole of the circuit board.

### SUMMARY OF THE INVENTION

The present invention has been made in view of these circumstances, and an object thereof is to provide a connector whose terminal portions of contacts can be reliably inserted into through holes of a circuit board.

To attain the above object, the present invention provides a connector comprising a housing, a plurality of contacts each including a holding portion that is held by said housing, a terminal portion that is inserted into a circuit board, a linking portion that connects said holding portion and said terminal portion, said terminal portion extending in a direction substantially orthogonal to said linking portion, said plurality of contacts being arranged in a predetermined direction, and at the same time, disposed in two rows in a terminal portion-inserting direction that is perpendicular to the predetermined direction, said linking portions of each predetermined pair of said contacts which are adjacent to each other in the predetermined direction being connected by a connecting portion, whereby a plurality of combination contacts are formed, and an alignment member that is mounted on said plurality of contacts, for positioning said terminal portions, said alignment member including receiving portions that receive said linking portions, open portions from which said connecting portions of said combination contacts in one row of the two rows are exposed to outside, and movement preventing portions that prevent a relative movement of said connecting portions of said combination contacts in the other row of the two rows, in a direction toward the one row.

With the arrangement of the connector according to the present invention, the alignment member includes the open portions from which the connecting portions of the combination contacts in the one row are exposed to outside, and the movement preventing portions that prevent the movement of the connecting portions of combination contacts in the other row, in a direction toward the one row. Therefore, it is possible to directly press the connecting portions of combination contacts in the one row to thereby press the alignment member in a direction toward the other row. When the connecting portions of the combination contacts in the one row are pressed to press the alignment member in the direction toward the other row, even if the combination contacts in the other row attempts to relatively move toward the one row, the movement of the combination contacts in the other row is prevented by the movement preventing portions, and all of the combination contacts in the other row move along the direction toward the other row, in unison with the alignment member.

Preferably, the connector comprises a plurality of signal contacts each including a signal-side holding portion that is held by said housing, a signal-side terminal portion that is inserted into the circuit board, and a signal-side linking portion that connects said signal-side holding portion and said signal-side terminal portion, and said alignment member includes signal-side receiving portions that receive said signal-side linking portions, three sides of said signal-side linking portion of each of said signal contacts being surrounded by said linking portions of said pair of said contacts and said connecting portion that connect said linking portions.

Preferably, a cross-section of said linking portions of said pair of said contacts and said connecting portion that connect said linking portions has a substantially U shape.

Preferably, said terminal portion and said signal-side terminal portion each have a press-fit structure to be pressed to inner peripheral surfaces of through holes of the circuit board.

According to the present invention, it is possible to reliably insert the terminal portions of the contacts into the through holes of the circuit board.

The above and other objects, features and advantages of the present invention will become more apparent from the following detailed description taken in conjunction with the accompanying drawings.

### BRIEF DESCRIPTION OF THE DRAWINGS

FIG. 1 is an enlarged view of part of a connector according to an embodiment of the present invention;

FIG. 2 is a cross-sectional view of the connector taken along line A-A in FIG. 1;

FIG. 3 is a cross-sectional view of the connector taken along line B-B in FIG. 1;

FIG. 4 is a cross-sectional view of the connector taken along line C-C in FIG. 1;

FIG. 5 is a perspective view of the connector partly in cross-section taken along line A-A shown in FIG. 1;

FIG. 6 is a perspective view of the connector partly in cross-section taken along line B-B shown in FIG. 1;

FIG. 7 is a perspective view of the connector partly in cross-section taken along line C-C shown in FIG. 1;

FIG. 8 is a perspective view of contacts of the connector shown in FIG. 1;

FIG. 9 is a perspective view of the contacts shown in FIG. 8 in a state in which the contacts are assembled;

FIG. 10 is a perspective view of an alignment member of the connector shown in FIG. 1;

FIG. 11 is a perspective view of the alignment member partly in cross-section taken along line A′-A′ in FIG. 1;

FIG. 12 is a perspective view of the alignment member partly in cross-section taken along line B′-B′ in FIG. 1;

FIG. 13 is a perspective view of the alignment member partly in cross-section taken along line C′-C′ in FIG. 1;

FIG. 14 is a schematic diagram showing a state in which combination contacts in an upper row of the connector shown in FIG. 1 are pressed;

FIG. 15 is a schematic diagram showing a state before a mating connector is connected to the connector shown in FIG. 1;

FIG. 16 is a schematic diagram showing a state in which the mating connector is fitted to a relay housing appearing in FIG. 15;

FIG. 17 is a schematic diagram showing a state before the mating connector shown in FIG. 15 is connected to the connector shown in FIG. 1;

FIG. 18 is a schematic diagram showing a state in which the mating connector shown in FIG. 15 is connected to the connector shown in FIG. 1;

FIG. 19 is a perspective view showing a state in which contacts of the connector shown in FIG. 1 are inserted into the mating connector shown in FIG. 15;

FIG. 20 is a perspective view showing a state in which the contacts appearing in FIG. 19 are elastically deformed; and

FIG. 21 is an enlarged view of a terminal portion of each contact of the connector shown in FIG. 1.

### DETAILED DESCRIPTION OF THE PREFERRED EMBODIMENTS

A connector according to a preferred embodiment of the present invention will now be described in detail with reference to the drawings.

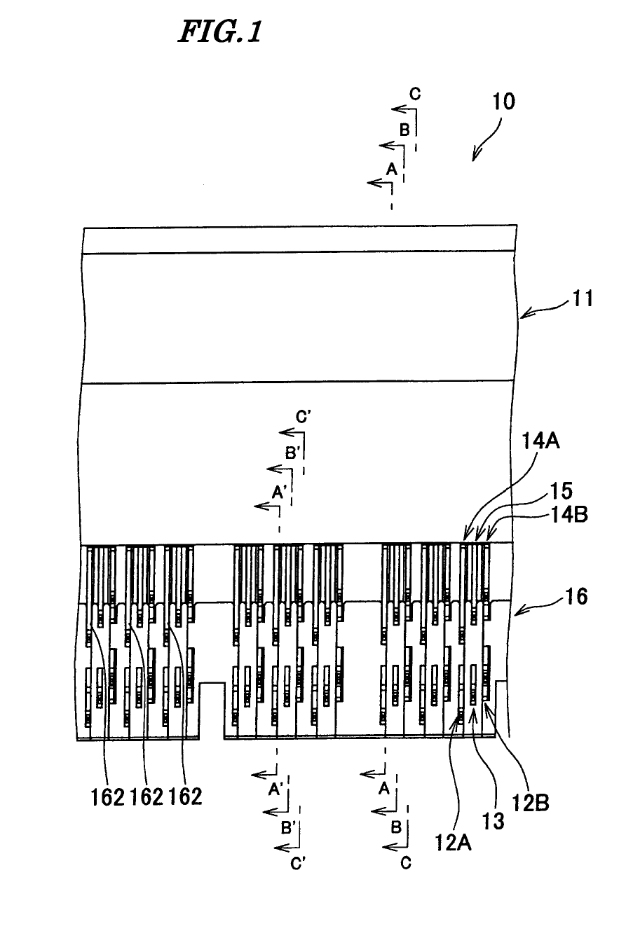

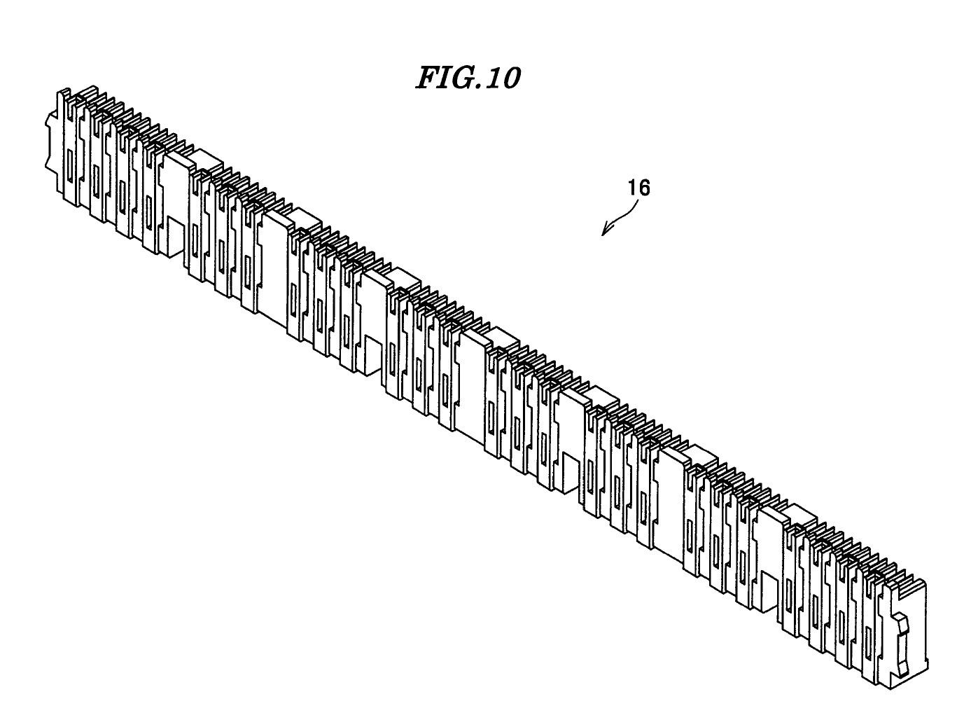

Referring to FIG. 1, reference numeral 10 denotes the connector which is comprised of a housing 11, first ground contacts (contacts) 12A, second ground contacts (contacts) 12B, first signal contacts 13, third ground contacts (contacts) 14A, fourth ground contacts (contacts) 14B, second signal contacts 15, and an alignment member 16 (see FIG. 10).

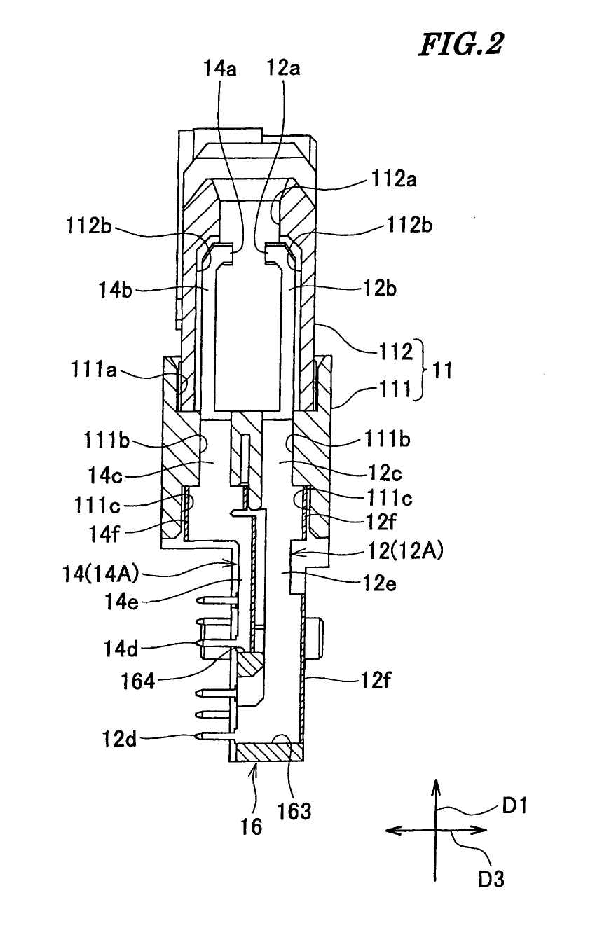

Referring to FIGS. 2 to 7, the housing 11 is comprised of a housing main body 111 and a fitting portion 112. In the present embodiment, when referring to the front, rear, top, and bottom sides of the connector 10, the upper, lower, right, and left sides of the connector 10 as viewed in FIG. 2 are referred to, respectively.

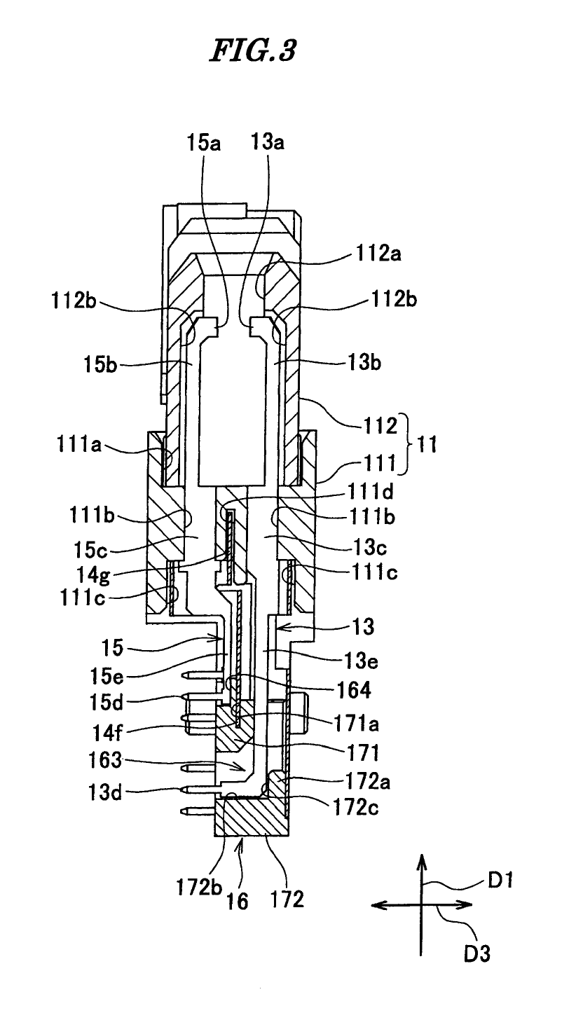

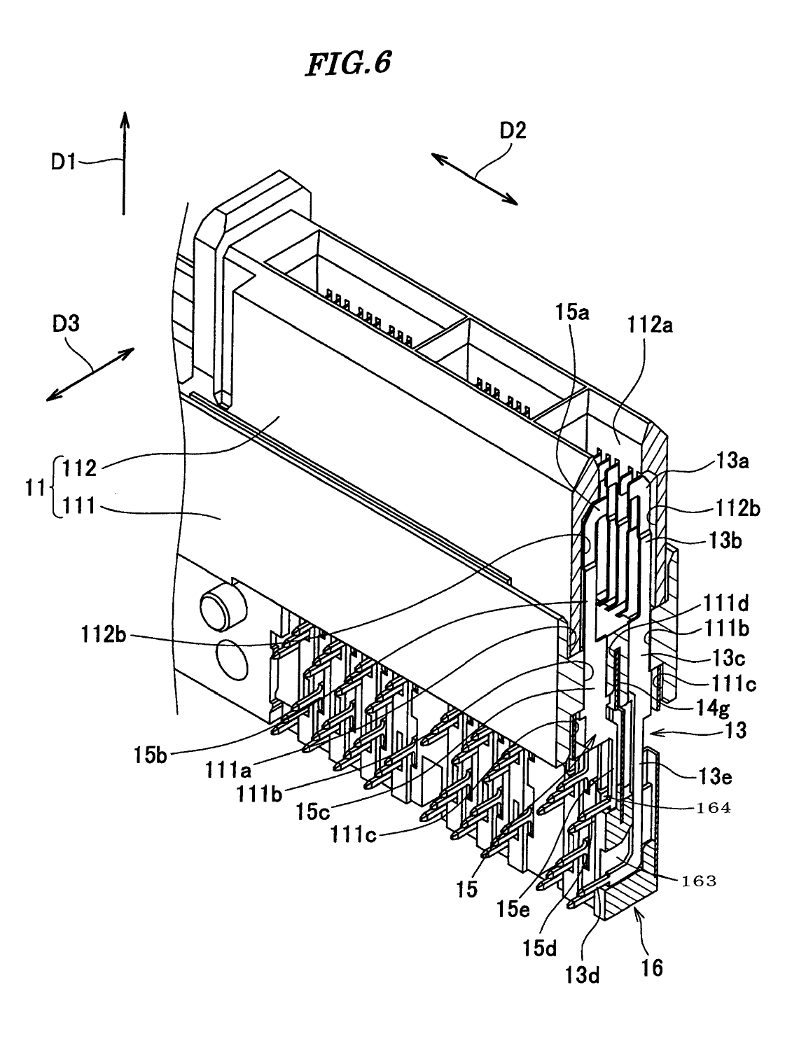

The housing main body 111 is formed of resin. The housing main body 111 has a recess 111a formed in a front portion thereof. Further, the housing main body 111 has a plurality of press-fitting holes 111b formed therein in two rows in the vertical direction thereof. The press-fitting holes 111b extend in a fitting direction D1, and communicate with the recess 111a. Also, the housing main body 111 has a plurality of holding holes 111c formed therein in two rows in the vertical direction thereof. The holding holes 111c extend in the fitting direction D1. The holding holes 111c are located rearward of the press-fitting holes 111b in the fitting direction D1 and communicate with the press-fitting holes 111b. Further, the housing main body 111 has a plurality of holding grooves 111d formed therein at predetermined space intervals in a longitudinal direction (predetermined direction) D2 of the connector 10 (see FIGS. 3 and 6). The plurality of holding grooves 111d are located upward of the press-fitting holes 111b in the lower row.

The fitting portion 112 is formed of resin. The fitting portion 112 is disposed in the recess 111a of the housing main body 111 such that it is movable in the longitudinal direction D2 of the connector 10. The fitting portion 112 has a plurality of receiving portions 112a formed therein. Receiving grooves 112b are formed in inner surfaces of each receiving portion 112a, which are opposed to each other in a vertical direction (terminal portion-inserting direction) D3. The receiving grooves 112b are disposed at predetermined space intervals in the longitudinal direction D2. The receiving grooves 112b are opposed to the press-fitting holes 111b of the housing main body 111 in the fitting direction D1.

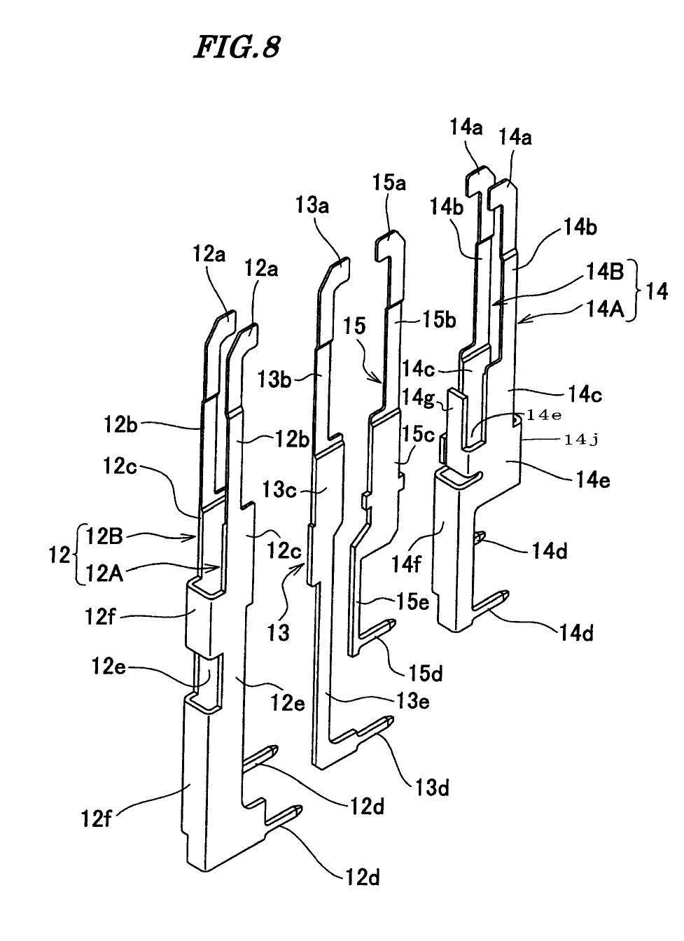

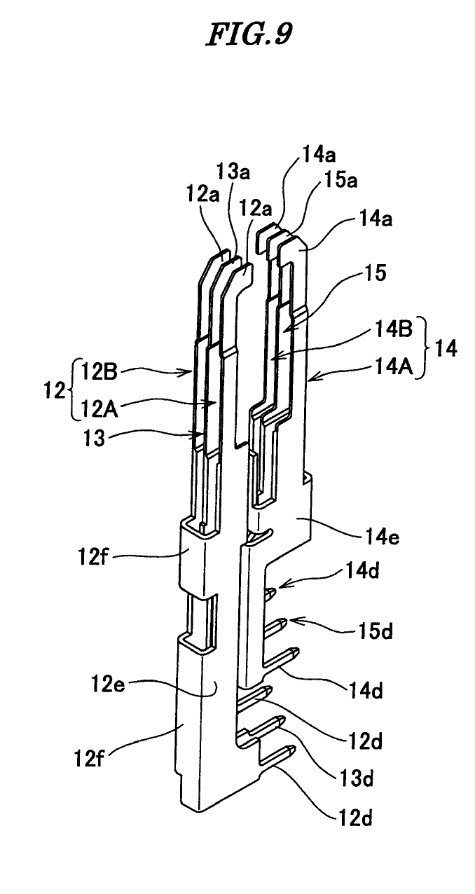

Referring to FIGS. 8 and 9, each first ground contact 12A includes a contact portion 12a, a spring portion 12b, a holding portion 12c, a terminal portion 12d, and a linking portion 12e.

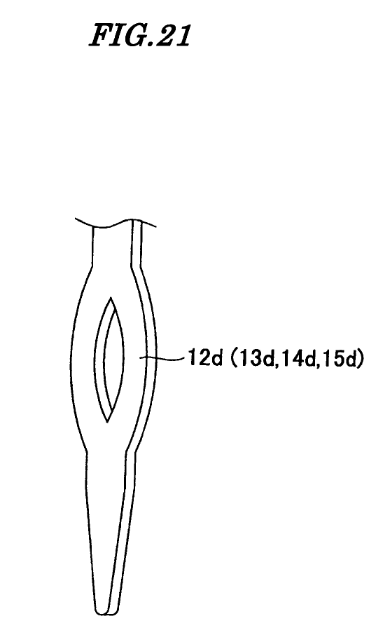

The contact portion 12a protrudes into an associated one of the receiving portions 112a of the fitting portion 112 (see FIG. 2). The spring portion 12b is continuous with the contact portion 12a and is received in an associated one of the receiving grooves 112b of the fitting portion 112. The holding portion 12c is continuous with the spring portion 12b and is press-fitted into an associated one of the press-fitting holes 111b of the housing main body 111 such that it is held in the housing main body 111. The terminal portion 12d is a terminal portion having a press-fit structure (the terminal portion is elastically deformed (or plastically deformed) to be press-fitted into a through hole of a circuit board, not shown such that it is held in the circuit board) (see FIG. 21). A longitudinal direction of the terminal portion 12d is substantially perpendicular to the fitting direction D1. The linking portion 12e connects the holding portion 12c and the terminal portion 12d to each other.

Each second ground contact 12B has substantially the same construction as that of the first ground contact 12A. Therefore, component parts of the second ground contact 12B identical to those of the first ground contact 12A are denoted by the same reference numerals in the figures, and detailed description thereof is omitted. The main difference between the first ground contact 12A and the second ground contact 12B is that the terminal portion 12d of the second ground contact 12B is located forward of the terminal portion 12d of the first ground contact 12A.

The first ground contact 12A and the second ground contact 12B i.e. predetermined (pair of) contacts, which are adjacent to each other in the longitudinal direction D2, are connected by a connecting portion 12f, to form a first combination contact (combination contact in the upper row) 12. The first combination contact 12 is formed by blanking and bending one metal plate.

Each first signal contact 13 includes a signal-side contact portion 13a, a signal-side spring portion 13b, a signal-side holding portion 13c, a signal-side terminal portion 13d, and a signal-side linking portion 13e.

The signal-side contact portion 13a protrudes into the associated receiving portion 112a of the fitting portion 112 (see FIG. 3). The signal-side spring portion 13b is continuous with the signal-side contact portion 13a and is received into an associated one of the receiving grooves 112b of the fitting portion 112. The signal-side holding portion 13c is continuous with the signal-side spring portion 13b, and is press-fitted into an associated one of the press-fitting holes 111b of the housing main body 111 such that it is held in the housing main body 111. The signal-side terminal portion 13d is a terminal portion having the press-fit structure (see FIG. 21), and a longitudinal direction thereof is substantially perpendicular to the fitting direction D1. The signal-side linking portion 13e connects the signal-side holding portion 13c and the signal-side terminal portion 13d to each other.

The first signal contact 13 is formed by blanking and bending a metal plate.

Each third ground contact 14A includes a contact portion 14a, a spring portion 14b, a holding portion 14c, a terminal portion 14d, a linking portion 14e, and an insertion portion 14g.

The contact portion 14a protrudes into the associated receiving portion 112a of the fitting portion 112 (see FIG. 2). The spring portion 14b is continuous with the contact portion 14a and is received in an associated one of the receiving grooves 112b of the fitting portion 112. The holding portion 14c is continuous with the spring portion 14b, and is press-fitted into an associated one of the press-fitting holes 111b of the housing main body 111 such that it is held in the housing main body 111. The terminal portion 14d is a terminal portion having a press-fit structure (see FIG. 21), and a longitudinal direction thereof is substantially perpendicular to the fitting direction D1. The linking portion 14e connects the holding portion 14c and the terminal portion 14d. The insertion portion 14g is continuous with the linking portion 14e of the third ground contact 14A and extends substantially parallel to the spring portion 14b.

Each fourth ground contact 14B has substantially the same construction as that of the third ground contact 14A. Therefore, component parts of the fourth ground contact 14B identical to those of the third ground contact 14A are denoted by the same reference numerals in the figures, and detailed description thereof is omitted. The main differences between the third ground contact 14A and the fourth ground contact 14B are that the terminal portion 14d of the fourth ground contact 14B is located forward of the terminal portion 14d of the third ground contact 14A and that the fourth ground contact 14B lacks the insertion portion 14g.

The third ground contact 14A and the fourth ground contact 14B, i.e. predetermined (pair of) contacts which are adjacent to each other in the longitudinal direction D2 are connected by a connecting portion 14f continuous to an upper and rear portion of the linking portion 14e of the third ground contact 14A and a connecting portion 14j continuous to a lower and front portion of the same, to form a second combination contact (combination contact in the lower row) 14. One end portion of the linking portion 14e of the third ground contact 14A is continuous with the connecting portion 14j, the other end portion is continuous with the insertion portion 14g. One end portion of the linking portion 14e of the fourth ground contact 14B is continuous with the connecting portion 14j, the other end portion is not continuous with the insertion portion 14g. The second combination contact 14 is formed by blanking and bending a metal plate.

Each second signal contact 15 includes a signal-side contact portion 15a, a signal-side spring portion 15b, a signal-side holding portion 15c, a signal-side terminal portion 15d, and a signal-side linking portion 15e.

The signal-side contact portion 15a protrudes into the associated receiving portion 112a of the fitting portion 112 (see FIG. 3). The signal-side spring portion 15b is continuous with the signal-side contact portion 15a and is received in an associated one of the receiving grooves 112b of the fitting portion 112. The signal-side holding portion 15c is continuous with the signal-side spring portion 15b, and is press-fitted into an associated one of the press-fitting holes 111b of the housing main body 111 such that it is held in the housing main body 111. The signal-side terminal portion 15d is a terminal portion having a press-fit structure (see FIG. 21), and a longitudinal direction thereof is substantially perpendicular to the fitting direction D1. The signal-side linking portion 15e connects the signal-side holding portion 15c and the signal-side terminal portion 15d.

The second signal contact 15 is formed by blanking and bending a metal plate.

Referring to FIGS. 10 to 13, the alignment member 16 includes a plurality of first receiving portions 161, a plurality of second receiving portions 162, a plurality of first signal-side receiving portions 163, a plurality of second signal-side receiving portions 164, a plurality of third receiving portions 167, a plurality of fourth receiving portions 168, and a plurality of open portions 169.

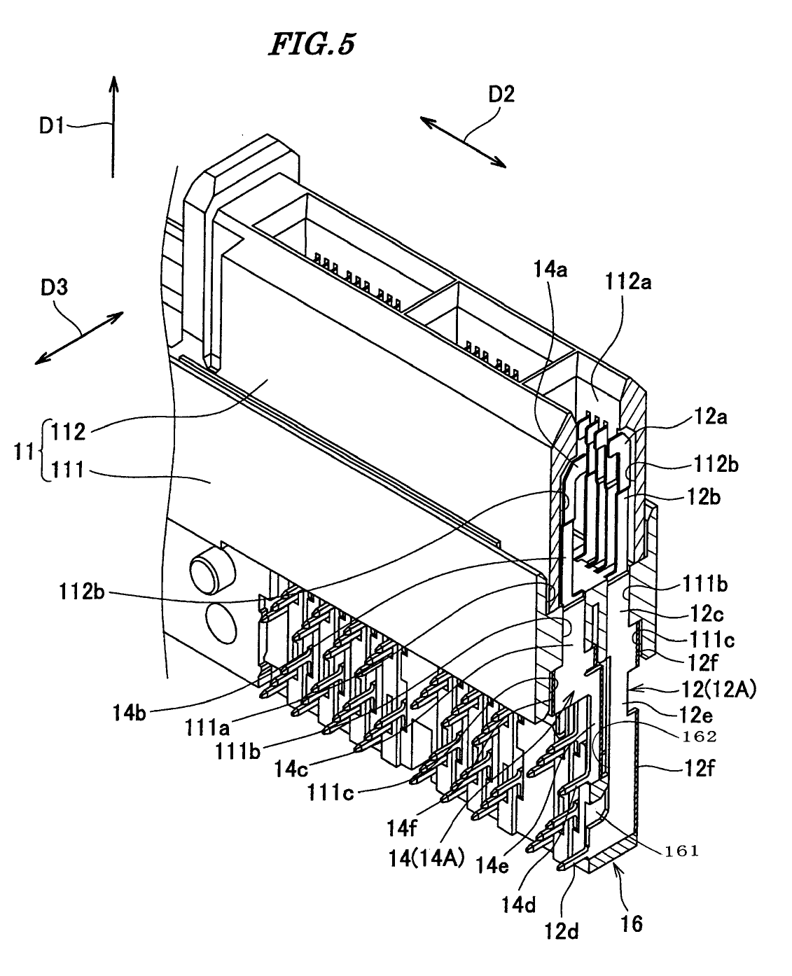

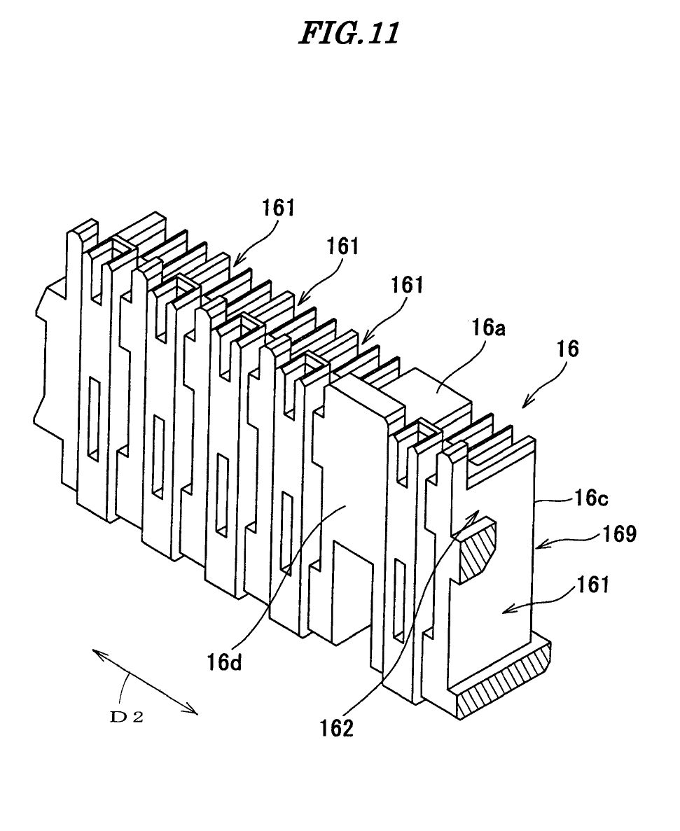

As shown in FIGS. 11 and 1, the plurality of first receiving portions 161 are formed at predetermined space intervals along the longitudinal direction D2. Each first receiving portion 161 opens in a front surface 16a, an upper surface 16c, and a lower surface 16d of the alignment member 16. Each first receiving portion 161 receives a rear portion of the linking portion 12e of an associated one of the first ground contacts 12A (see FIGS. 2 and 5). The plurality of second receiving portions 162 are formed at predetermined space intervals along the longitudinal direction D2. Each second receiving portion 162 is continuous with an associated one of the first receiving portions 161 and opens in the front surface 16a, the lower surface 16d, and the upper surface 16c of the alignment member 16. Each second receiving portion 162 receives a rear portion of the linking portion 14e of an associated one of the third ground contacts 14A (see FIGS. 2 and 5).

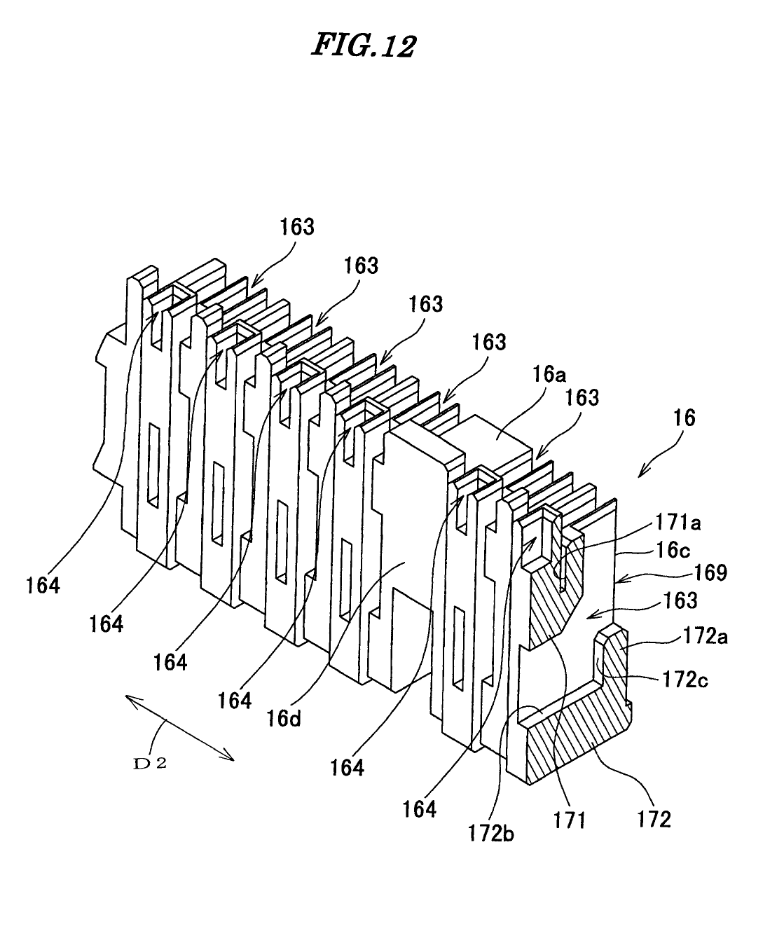

Referring to FIG. 12, the plurality of first signal-side receiving portions 163 are formed at predetermined space intervals along the longitudinal direction D2. Each first signal-side receiving portion 163 has a substantially L shape and opens in the front surface 16a, the upper surface 16c, and the lower surface 16d of the alignment member 16. Each first signal-side receiving portion 163 receives a rear portion of the signal-side linking portion 13e of an associated one of the first signal contacts 13 (see FIGS. 3 and 6). The plurality of second signal-side receiving portions 164 are formed at predetermined space intervals along the longitudinal direction D2. Each second signal-side receiving portion 164 is formed in a front portion of the alignment member 16 and opens in the front surface 16a and the lower surface 16d of the alignment member 16. Each second signal-side receiving portion 164 receives a rear portion of the signal-side linking portion 15e of an associated one of the second signal contacts 15 (see FIGS. 3 and 6).

A groove 171a is formed in a linking portion 171 that connects two inner surfaces of each first signal-side receiving portion 163 opposed to each other in the longitudinal direction D2. A linking portion 172 located rearward of each first signal-side receiving portion 163 includes a protruding portion 172a. The groove 171a receives a rear portion of the connecting portion 14f of an associated one of the second combination contacts 14 and prevents the second combination contact 14 from moving upward relative to the alignment member 16. Thus, a movement preventing portion that prevents the upward movement of the second combination contact 14 is formed by an inner surface of each groove 171a.

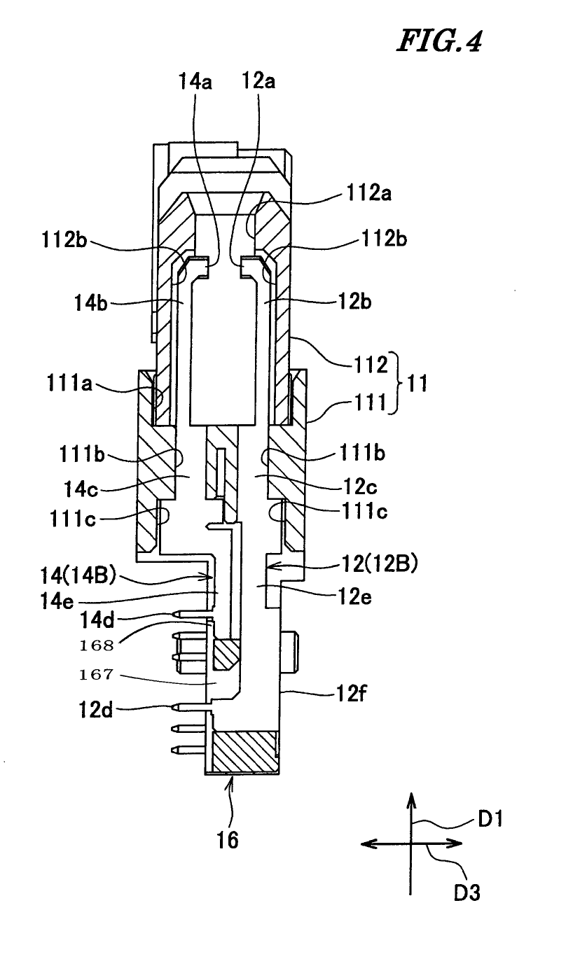

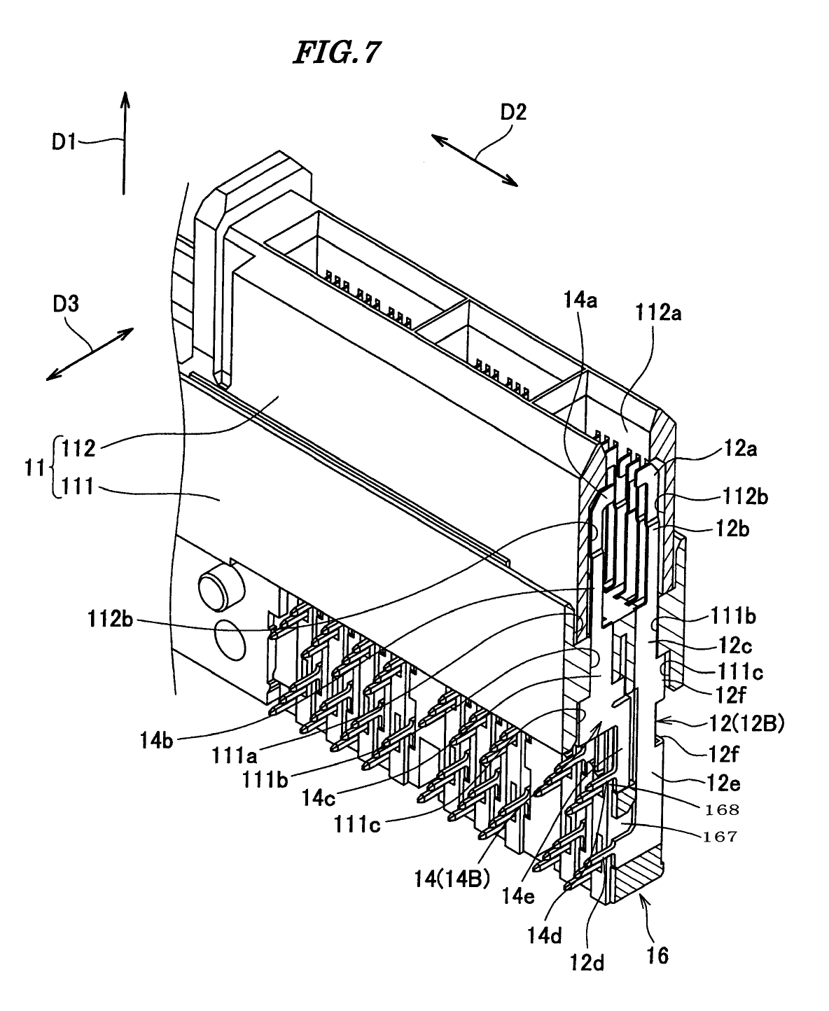

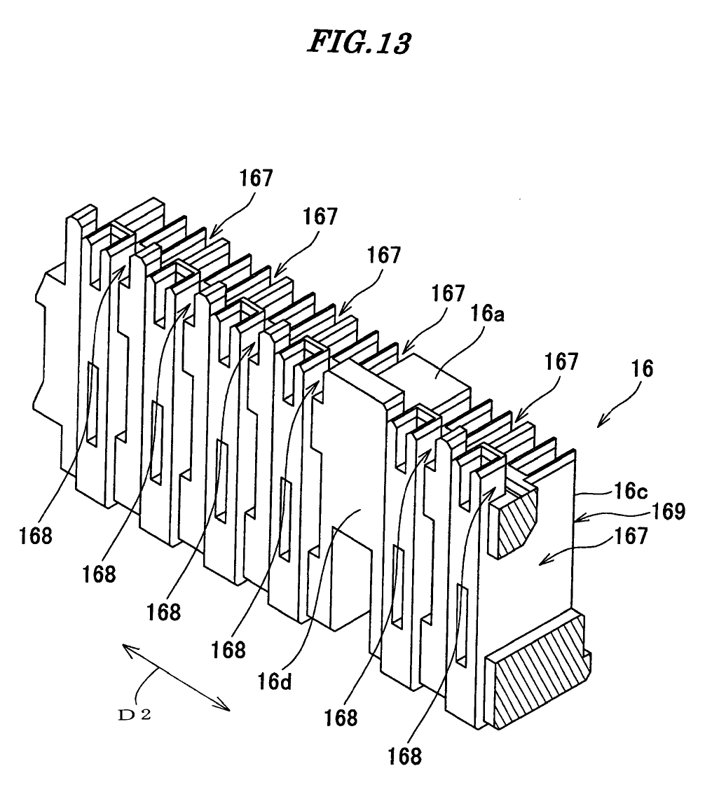

Referring to FIG. 13, the plurality of third receiving portions 167 are formed at predetermined space intervals along the longitudinal direction D2. Each third receiving portion 167 has a substantially L shape and opens in the front surface 16a, the upper surface 16c, and the lower surface 16d of the alignment member 16. Each third receiving portion 167 receives a rear portion of the linking portion 12e of an associated one of the second ground contacts 12B (see FIGS. 4 and 7). The plurality of fourth receiving portions 168 are formed at predetermined space intervals along the longitudinal direction D2. Each fourth receiving portion 168 is formed in the front portion of the alignment member 16 and opens in the front surface 16a and the lower surface 16d of the alignment member 16. Each fourth receiving portion 168 receives a rear portion of the linking portion 14e of an associated one of the fourth ground contacts 14B (see FIGS. 4 and 7).

As described above, the first receiving portions 161, the first signal-side receiving portions 163, and the third receiving portions 167 have respective openings in the upper surface 16c of the alignment member 16, and these openings form the open portions 169.

To assemble the connector 10, first, as shown in FIGS. 2, 4, 5, and 7, the holding portions 12c and 12c of each first combination contact 12 are press-fitted into an associated one of the press-fitting holes 111b in the upper row of the housing main body 111, and the holding portions 14c and 14c of each second combination contact 14 are press-fitted into respective associated ones of the press-fitting holes 111b in the lower row of the housing main body 111. At this time, the spring portions 12b and 12b of each first combination contact 12 are inserted into respective associated ones of the receiving grooves 112b in the upper row of the fitting portion 112, and front portions of the linking portions 12e, 12e and the connecting portion 12f of the first combination contact 12 are inserted into the associated holding hole 111c in the upper row. Also, the spring portions 14b and 14b of each second combination contact 14 are inserted into respective associated ones of the receiving grooves 112b in the lower row of the fitting portion 112, and front portions of the linking portions 14e, 14e and the connecting portion 14j of the second combination contact 14 are inserted into the associated holding hole 111c in the lower row. Further, the insertion portion 14g of each second combination contact 14 is inserted into an associated one of the holding grooves 111d (see FIGS. 3 and 6).

Further, as shown in FIGS. 3 and 6, the signal-side holding portion 13c of each first signal contact 13 is press-fitted into an associated one of the press-fitting holes 111b in the upper row of the housing main body 111, and the signal-side holding portion 15c of each second signal contact 15 is press-fitted into an associated one of the press-fitting holes 111b in the lower row of the housing main body 111. At this time, the signal-side spring portion 13b of each first signal contact 13 is inserted into an associated one of the receiving grooves 112b in the upper row of the fitting portion 112, and a front portion of the signal-side linking portion 13e of each first signal contact 13 is inserted into an associated one the holding holes 111c in the upper row of the housing main body 111. Also, the signal-side spring portion 15b of each second signal contact 15 is inserted into an associated one of the receiving grooves 112b in the lower row of the fitting portion 112, and a front portion of the signal-side linking portion 15e of each second signal contact 15 is inserted into an associated one of the holding holes 111c in the lower row of the housing main body 111.

Finally, the respective rear portions of the linking portions 12e and 12e of each first combination contact 12, the rear portion of the signal-side linking portion 13e of each first signal contact 13, the respective rear portions of the linking portions 14e and 14e of each second combination contact 14, and the rear portion of the signal-side linking portion 15e of each second signal contact 15 are respectively inserted into the first and third receiving portions 161, 167, the first signal-side receiving portion 163, the second and fourth receiving portions 162 and 168, and the second signal-side receiving portion 164 of the alignment member 16.

The process of inserting the contacts into the alignment member 16 is performed in accordance with the following procedure.

First, the terminal portions 12d and 12d of each first combination contact 12 and the signal-side terminal portion 13d of each first signal contact 13 are respectively inserted into the first receiving portions 161, the third receiving portions 167, and the first signal-side receiving portions 163 of the alignment member 16 from the front side, and the terminal portions 12d, 12d, and 13d are pushed in along the fitting direction D1 until the rear portion of the signal-side linking portion 13e of the first signal contact 13 is brought into abutment with an associated one of the protruding portions 172a of the alignment member 16.

Next, all of the contacts 12, 13, 14, and 15 are pressed in downward along the vertical direction D3 until the signal-side linking portion 13e of the first signal contact 13 is brought into abutment with an associated one of the linking portions 171.

Finally, all of the contacts 12, 13, 14, and 15 are pressed in rearward along the fitting direction D1 until the rear portion of the signal-side linking portion 13e of the first signal contact 13 is brought into abutment with a supporting surface 172b (see FIG. 3) of an associated one of the linking portions 172. At this time, the rear portion of the signal-side linking portion 13e of the first signal contact 13 is brought into contact with a supporting surface 172c (see FIG. 3) of an associated one of the protruding portions 172a, whereby an upward movement of the first signal contact 13 is prevented. Also, the rear portion of the connecting portion 14f of the second combination contact 14 fits in an associated one of the grooves 171a, whereby an upward movement of the second combination contact 14 is prevented. Further, a rear end portion of the signal-side linking portion 15e of the second signal contact 15 is received in an associated one of the second signal-side receiving portions 164, whereby an upward movement of the second signal contacts 15 is prevented.

To press-fit the terminal portions 12d, 13d, 14d, and 15d of the first combination contacts 12, the first signal contacts 13, the second combination contacts 14, and the second signal contacts 15 into through holes of a printed board, not shown, first, a front end portion of each of the terminal portions 12d, 13d, 14d, and 15d is inserted into the through holes.

Next, all of the connecting portions 12f of the first combination contacts 12 that are exposed outside through the open portions 169 are simultaneously pressed downward by using a plate-shaped jig (not shown).

The pressing force acting on the connecting portions 12f via the jig is applied to the terminal portions 12d via the linking portions 12e.

Also, the connecting portions 12f pressed by the jig press the alignment member 16. At this time, the supporting surfaces 172c of the protruding portions 172a, the inner surfaces of the grooves 171a of the linking portions 171, and the inner surfaces of the second signal-side receiving portions 164 of the alignment member 16 press the first signal contacts 13, the second combination contacts 14, and the second signal contacts 15, respectively.

As a result of the aforementioned process, the terminal portions 12d, 13d, 14d, and 15d are elastically deformed (or plastically deformed), whereby the terminal portions 12d, 13d, 14d, and 15d are press-fitted into the through holes.

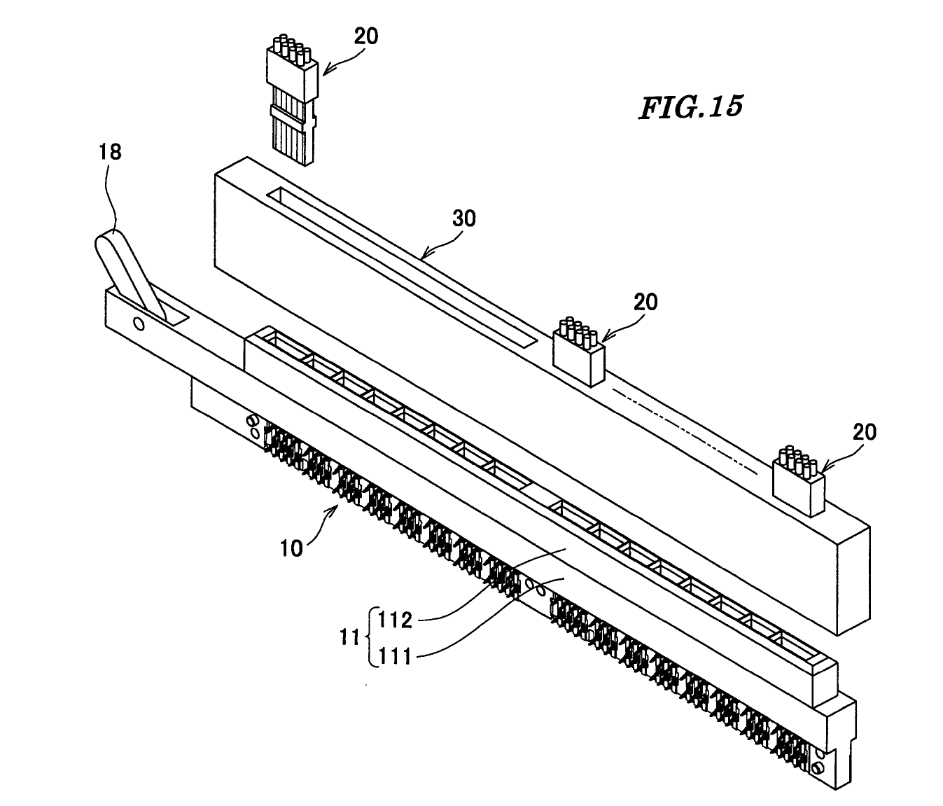

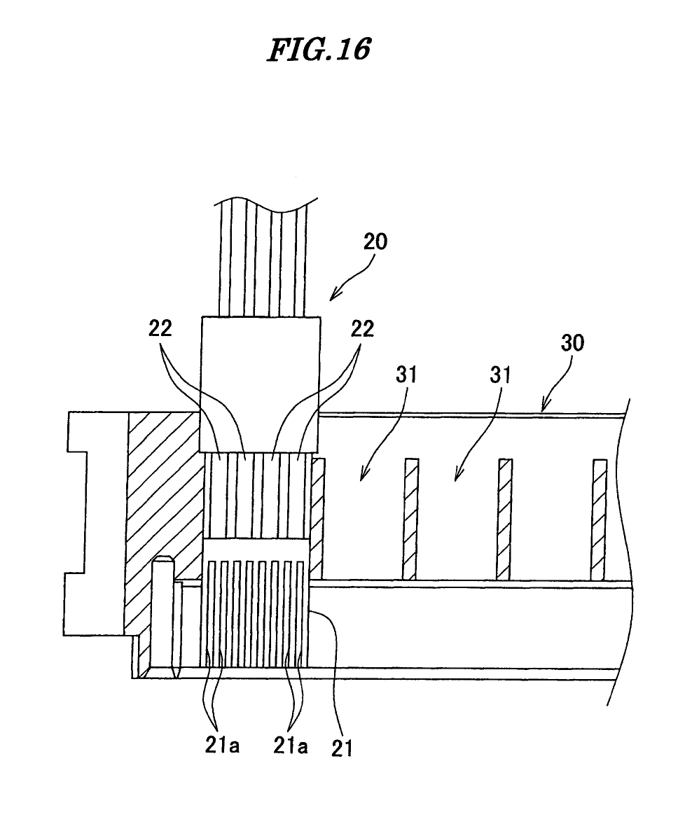

As shown in FIGS. 15 and 16, to connect the connector 10 to cable connectors 20, which are mating connectors, first, the cable connectors 20 are respectively inserted into a plurality of receiving portions 31 of a relay housing 30.

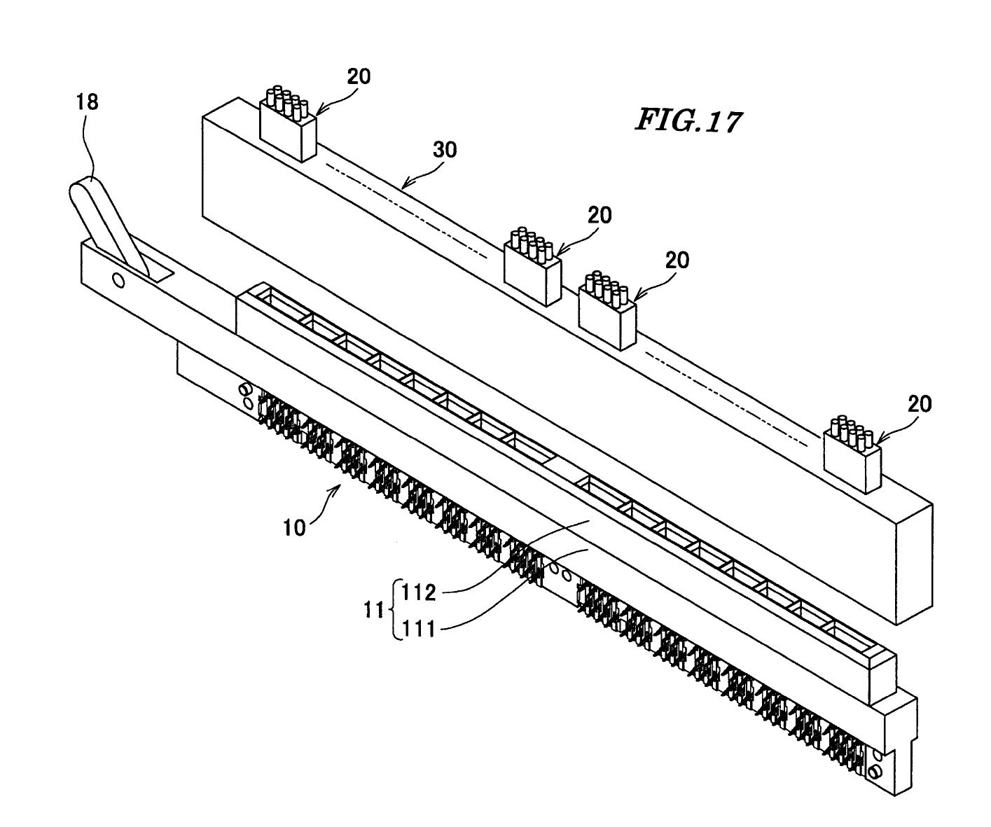

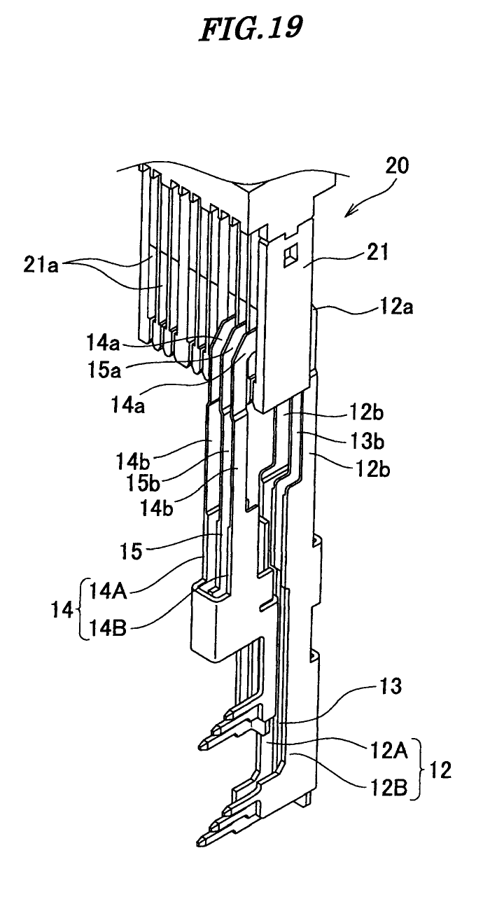

As shown in FIG. 17, after all of the cable connectors 20 are inserted into the relay housing 30, the fitting portion 112 of the connector 10 is placed on a fitting position. At this time, the spring portions 12b, 13b, 14b, and 15b of the first combination contacts 12, the first signal contacts 13, the second combination contacts 14, and the second signal contacts 15 are not elastically deformed and are in a straight state (see FIG. 19).

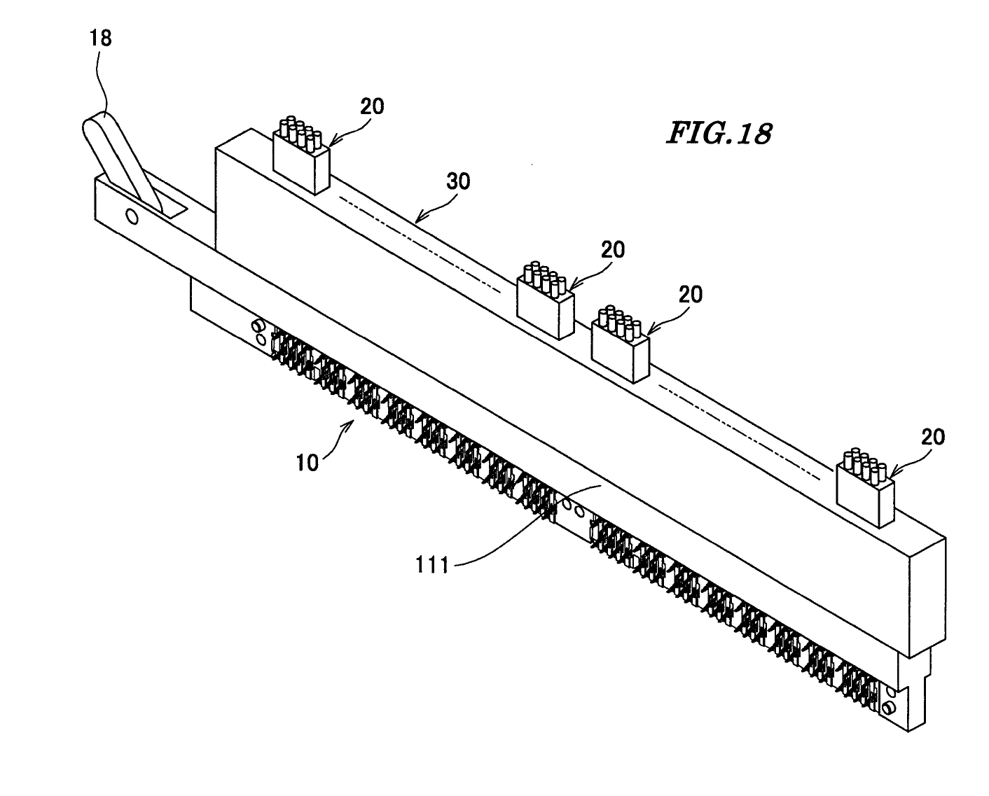

Next, the relay housing 30 is fitted to the fitting portion 112 of the connector 10 (see FIG. 18). As a result, as shown in FIG. 19, the contact portions 12a, 13a, 14a, and 15a of the first combination contacts 12, the first signal contacts 13, the second combination contacts 14, and the second signal contacts 15 are respectively inserted into a plurality of slits 21a formed in a housing 21 of each cable connector 20. In the slits 21a, contact portions (not shown) of contacts 22 (see FIG. 16) of the cable connectors 20 are disposed.

Finally, a lever 18 of the connector 10 is rotated in a predetermined direction to cause the fitting portion 112 to slide in the longitudinal direction D2.

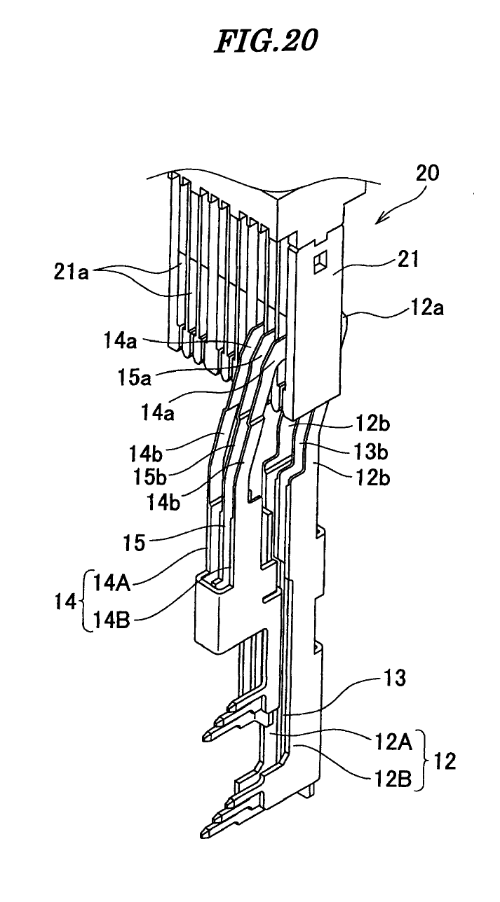

As a result, the spring portions 12b, 13b, 14b, and 15b of the first combination contacts 12, the first signal contacts 13, the second combination contacts 14, and the second signal contacts 15 are bent (see FIG. 20), so that the contact portions 12a, 13a, 14a, and 15a are pressed to the contact portions of the contacts 22 of the cable connectors 20 by the spring forces of the spring portions 12b, 13b, 14b, and 15b trying to return to their original states, whereby the connector 10 and the cable connectors 20 are electrically connected.

According to the connector 10 of the present embodiment, the pressing force applied to the connecting portions 12f is positively transmitted to the terminal portions 12d via the linking portions 12e, and to the terminal portions 14d and the signal-side terminal portions 13d and 15d other than the terminal portions 12d via the alignment member 16. Therefore, it is possible to reliably insert the terminal portions 12d and 14d and the signal-side terminal portions 13d and 15d into the through holes of the printed board.

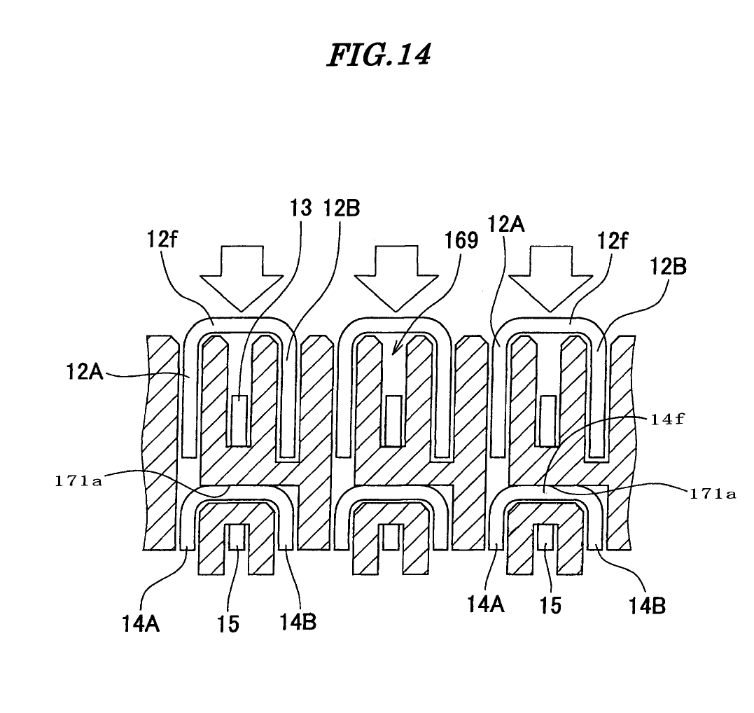

Further, three sides of each first signal contact 13 are in a state surrounded by the first ground contact 12A, the second ground contact 12B, and the connecting portion 12f (see FIG. 14), and three sides of each second signal contact 15 are in a state surrounded by the third ground contact 14A, the fourth ground contact 14B, and the connecting portion 14f. Therefore, it is possible to improve shielding properties.

Since the contact portions 12a, 13a, 14a, and 15a of the first combination contacts 12, the first signal contacts 13, the second combination contacts 14, and the second signal contacts 15 are brought into direct contact with the contact portions of the contacts 22 of the cable connectors 20, a relay contact is no longer required.

The first combination contacts 12 and the first signal contacts 13, and the second combination contacts 14 and the second signal contacts 15 are arranged along the vertical direction D3 of the connector 10. Therefore, compared to a connector where the contacts in the upper row and the contacts in the lower row are staggered in the longitudinal direction D2 by half a pitch, it is possible to make the connector 10 compact in size.

It should be noted that although the cross-sectional shapes of the first combination contacts 12 and the second combination contacts 14 are substantially U-shaped at the connecting portions 12f and 14f, respectively, the cross-sectional shapes of the first combination contacts 12 and the second combination contacts 14 are not limited to the substantially U shape.

Further, although the terminal portions 12d, 13d, 14d, and 15d are terminal portions having the press-fit structure, the structure of the terminal portions may be of a pin type and a socket type but are not limited to the press-fit structure.

It is further understood by those skilled in the art that the foregoing are the preferred embodiments of the present invention, and that various changes and modification may be made thereto without departing from the spirit and scope thereof.

What is claimed is:

1. A connector comprising:
a housing;
a plurality of contacts each including a holding portion that is held by said housing, a terminal portion that is inserted into a circuit board, a linking portion that connects said holding portion and said terminal portion,
said terminal portion extending in a direction substantially orthogonal to said linking portion,
said plurality of contacts being arranged in a predetermined direction, and at the same time, disposed in two rows in a terminal portion-inserting direction that is perpendicular to the predetermined direction,
said linking portions of each predetermined pair of said contacts which are adjacent to each other in the predetermined direction being connected by a connecting portion, whereby a plurality of combination contacts are formed; and
an alignment member that is mounted on said plurality of contacts, for positioning said terminal portions,
said alignment member including receiving portions that receive said linking portions, open portions from which said connecting portions of said combination contacts in one row of the two rows are exposed to outside, and movement preventing portions that prevent a relative movement of said connecting portions of said combination contacts in the other row of the two rows, in a direction toward the one row.

2. The connector as claimed in claim 1, comprising a plurality of signal contacts each including a signal-side holding portion that is held by said housing, a signal-side terminal portion that is inserted into the circuit board, and a signal-side linking portion that connects said signal-side holding portion and said signal-side terminal portion,
wherein said alignment member includes signal-side receiving portions that receive said signal-side linking portions, and
wherein three sides of said signal-side linking portion of each of said signal contacts are surrounded by said linking portions of said pair of said contacts and said connecting portion that connect said linking portions.

3. The connector as claimed in claim 1, wherein a cross-section of said linking portions of said pair of said contacts and said connecting portion that connect said linking portions has a substantially U shape.

4. The connector as claimed in claim 2, wherein a cross-section of said linking portions of said pair of said contacts and said connecting portion that connect said linking portions has a substantially U shape.

5. The connector as claimed in claim 1, wherein said terminal portion and said signal-side terminal portion each have a press-fit structure to be pressed to inner peripheral surfaces of through holes of the circuit board.

6. The connector as claimed in claim 2, wherein said terminal portion and said signal-side terminal portion each have a press-fit structure to be pressed to inner peripheral surfaces of through holes of the circuit board.

7. The connector as claimed in claim 3, wherein said terminal portion and said signal-side terminal portion each have a press-fit structure to be pressed to inner peripheral surfaces of through holes of the circuit board.

8. The connector as claimed in claim 4, wherein said terminal portion and said signal-side terminal portion each have a press-fit structure to be pressed to inner peripheral surfaces of through holes of the circuit board.
